(19) United States
(12) Patent Application Publication
(10) Pub. No.: US 2012/0234998 A1
(43) Pub. Date: Sep. 20, 2012

(54) MODULE PURLIN CLAMP

(76) Inventor: Paul Anthony Tomaso, Jersey City, NJ (US)

(21) Appl. No.: 13/419,518

(22) Filed: Mar. 14, 2012

Related U.S. Application Data
(60) Provisional application No. 61/453,419, filed on Mar. 16, 2011.

(51) Int. Cl. F16B 2/06

(52) U.S. Cl. 248/228.1

(57) ABSTRACT

The present invention is a solar module purlin clamp includes a bent bracket with a top and a bottom that matches and accommodates a width of a supporting purlin, a clamp portion that tightens the module purlin clamp to the supporting purlin and a bolt stack fastener that controls spacing between the bent bracket and the supporting purlin and an inverted L-shaped bracket that has a vertical side and a horizontal side with a pair of edges. The solar module purlin clamp is a purlin of a carport installation.

This application claims priority to U.S. Provisional Application 61/453,419 filed on Mar. 16, 2011, the entire disclosure of which is incorporated herein by reference.

### TECHNICAL FIELD & BACKGROUND

The present invention generally relates to a clamp. More specifically, the invention is a module purlin clamp.

It is an object of the invention to provide a C-shaped module purlin clamp that provides ease of installation and tolerance adjustment for a solar module type of module in a carport installation.

It is an object of the invention to provide a module purlin clamp that can slide along the length of a supporting purlin to allow one or more connections at any location along the purlin, and has a top slot to allow for an adjustment tolerance in an opposite direction.

It is an object of the invention to provide a module purlin clamp that has an installation tolerance that includes a screw that self-spaces the module.

What is really needed is a module purlin clamp that provides ease of installation and tolerance adjustment for a solar module type of module in a carport installation that can slide along the length of a supporting purlin to allow one or more connections at any location along the purlin, and has a top slot to allow for an adjustment tolerance in an opposite direction that has an installation tolerance that includes a screw that self-spaces the module.

### BRIEF DESCRIPTION OF THE DRAWINGS

The present invention will be described by way of exemplary embodiments, but not limitations, illustrated in the accompanying drawing in which like references denote similar elements, and in which:

FIG. 1 illustrates an environmental side view of a module purlin clamp, in accordance with one embodiment of the present invention.

FIG. 2A illustrates a side perspective view of a module purlin clamp, in accordance with one embodiment of the present invention.

FIG. 2B illustrates an exploded side perspective view of a module purlin clamp, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

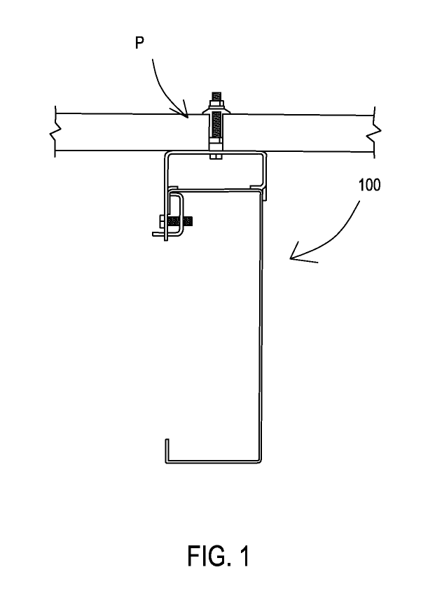

FIG. 1 illustrates an environmental side view of a module purlin clamp 100, in accordance with one embodiment of the present invention. The module purlin clamp 100 provides ease of installation and tolerance adjustment for any solar module type movably attached on a purlin P in a carport installation, which is traditionally performed in a solar module type of carport installation. The solar module type can be any suitable solar module type and the carport installation can be any suitable carport installation.

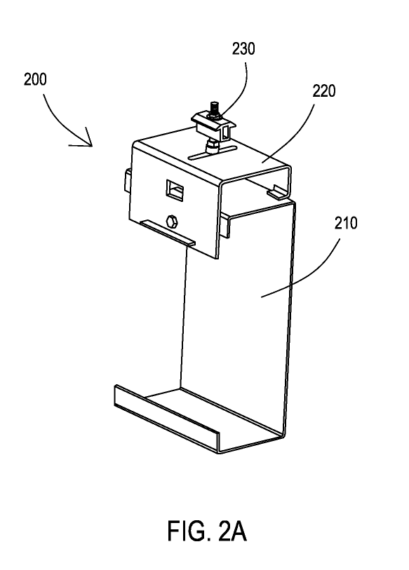

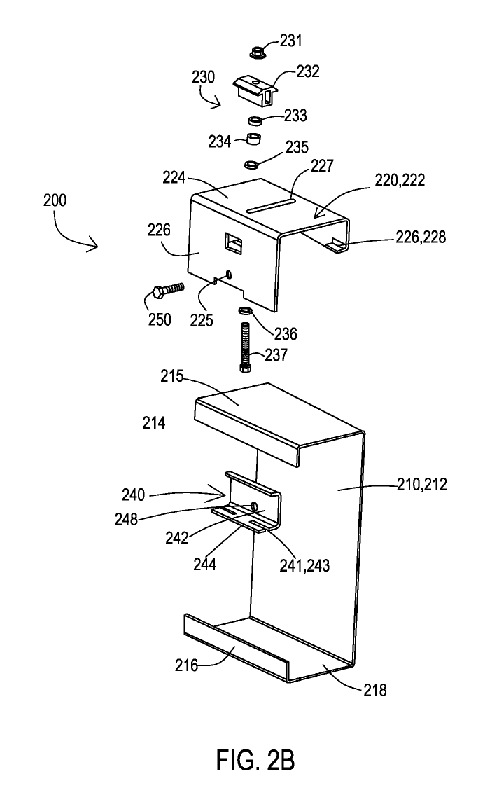

FIG. 2A illustrates a side perspective view of a module purlin clamp 200, in accordance with one embodiment of the present invention. The module purlin clamp 200 includes a bent bracket 210, a clamp portion 220 and a bolt stack fastener 230. The bent bracket 210 matches and accommodates a width of a supporting purlin P, typically of a carport installation but can be for any supporting purlin P. The bent bracket 210 is typically made of galvanized steel but can be made of other suitable materials. The clamp portion 220 tightens the module purlin clamp 200 to the supporting purlin P and is described in greater detail in FIG. 2B and its illustration and description. The clamp portion 220 is typically made of galvanized steel but can be made of other suitable materials. The bolt stack fastener 230 controls the spacing between the bent bracket 210 and the supporting purlin P and secures the module purlin clamp 200 to the supporting purlin P. The bolt stack fastener 230 is described in greater detail in FIG. 2B and its illustration and description.

FIG. 2B illustrates an exploded side perspective view of a module purlin clamp 200, in accordance with one embodiment of the present invention. The module purlin clamp 200 includes similar features to the module purlin clamp 200 illustrated and described in FIG. 2A and its description that include the module purlin clamp 200 that includes a bent bracket 210, the clamp portion 220 and the bolt stack fastener 230. The module purlin clamp 200 additionally includes an inverted L-shaped bracket 240 and a second cap screw 250.

The bent bracket 210 is a C-shaped bracket 212 with a perpendicular downward edge 214 disposed on the top 215 of the bent bracket 210 and a perpendicular upward edge 216 disposed on the bottom 218 of the bent bracket 210. The clamp portion 220 is a perpendicular clamp 222 with a vertical side 224, a horizontal side 226 and a curved outer edge 228 on the horizontal side 226. The vertical side 224 has an aperture 225 disposed on the vertical side 224. The horizontal side 226 has a slot 227 disposed lengthwise on a middle portion 229 of the horizontal side 226. The bolt stack fastener 230 includes a flange head locknut 231, a mid-clamp 232, a head nut 233, an unthreaded spacer 234, a washer 235, a tooth lock washer 236 and a first cap screw 237. The first cap screw 237 is inserted upwards through the slot 227 on the horizontal side 226 of the clamp portion 220. The flange head locknut 231 is placed on top of the first cap screw 237. The mid-clamp 232 is placed underneath the flange head locknut 231 on the first cap screw 237 and the head nut 233 is placed underneath the flange head locknut 231 on the first cap screw 237. The unthreaded spacer 234 is placed underneath the head nut 233 on the first cap screw 237 and the washer 235 is placed underneath the unthreaded spacer 234 on the first cap screw 237. The tooth lock washer 236 provides additional strength to the bolt stack fastener 230 that is placed underneath the washer 235 on the first cap screw 237.

The inverted L-shaped bracket 240 has a vertical side 242 and a horizontal side 244. The vertical side 242 includes a perpendicular protruding top edge 246 and centered aperture 248. The horizontal side 244 has a pair of centered slots 241 extending inward from the edges 243 of the horizontal side 244. The second cap screw 250 is inserted through the aperture 225 disposed on the vertical side 224 of the clamp portion 220 and the centered aperture 248 of the vertical side 242 of the inverted L-shaped bracket 240 that are correspondingly aligned to receive the second cap screw 250. The second cap screw 250 releasably secures the clamp portion 220 and the inverted L-shaped bracket 240 together.

The module purlin clamp provides ease of installation and tolerance adjustment for any suitable solar module type in a suitable carport installation. It can slide along the length of a supporting purlin to allow connections at any locations, and has a slot to allow for an approximate +/−0.75″ adjustment tolerance in an opposite direction. In addition to the installation tolerance, the screw has an approximate 0.50″ spacer included so that it self-spaces the modules, which saves labor.

The use of the module purlin clamp is traditionally intended for carport solar installations with a C-shaped purlin supporting structure. The module purlin clamp contains 3 main parts that include a bent galvanized steel bracket, which matches the width of the supporting purlin, a bent galvanized steel clamp, which tightens the assembly to a supporting purlin, and a bolt stack assembly for spacing and securing the modules.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A solar module purlin clamp, comprises:
a bent bracket with a top and a bottom that matches and accommodates a width of a supporting purlin;
a clamp portion that tightens said module purlin clamp to said supporting purlin; and
a bolt stack fastener that controls spacing between said bent bracket and said supporting purlin; and
an inverted L-shaped bracket that has a vertical side and a horizontal side with a pair of edges.

2. The clamp according to claim 1, wherein said supporting purlin is a purlin of a carport installation.

3. The clamp according to claim 1, wherein said bent bracket is made of galvanized steel.

4. The clamp according to claim 1, wherein said bent bracket is a C-shaped bracket.

5. The clamp according to claim 1, wherein said bent bracket has a perpendicular downward edge disposed on said top of said bent bracket and a perpendicular upward edge disposed on said bottom of said bent bracket.

6. The clamp according to claim 1, wherein said clamp portion is made of galvanized steel.

7. The clamp according to claim 1, wherein said bolt stack fastener secures said module purlin clamp to said supporting purlin.

8. The clamp according to claim 1, wherein said bolt stack fastener includes a flange head locknut, a mid-clamp, a head nut, an unthreaded spacer, a washer, a tooth lock washer and a first cap screw with a top.

9. The clamp according to claim 8, wherein said first cap screw is inserted upwards through said slot on said horizontal side of said clamp portion.

10. The clamp according to claim 9, wherein said flange head locknut is placed on said top of said first cap screw.

11. The clamp according to claim 10, wherein said mid-clamp is placed underneath said flange head locknut on said first cap screw.

12. The clamp according to claim 11, wherein said head nut is placed underneath said flange head locknut on said first cap screw.

13. The clamp according to claim 12, wherein said unthreaded spacer is placed underneath said head nut on said first cap screw and said washer is placed underneath said unthreaded spacer on said first cap screw.

14. The clamp according to claim 13, wherein said tooth lock washer provides additional strength to said bolt stack fastener placed underneath said washer on said first cap screw.

15. The clamp according to claim 1, wherein said vertical side of said inverted L-shaped bracket includes a perpendicular protruding top edge.

16. The clamp according to claim 1, wherein said vertical side of said inverted L-shaped bracket has a centered aperture.

17. The clamp according to claim 1, wherein said horizontal side has a pair of centered slots extending inward from said edges of said horizontal side.

18. The clamp according to claim 1, wherein said second cap screw is inserted through said aperture disposed on said vertical side of said clamp portion.

19. The clamp according to claim 1, wherein said centered aperture of said vertical side of said inverted L-shaped bracket are correspondingly aligned to receive said second cap screw.

20. The clamp according to claim 1, wherein said second cap screw releasably secures said clamp portion and said inverted L-shaped bracket together.
